(19) United States
(12) Patent Application Publication
(10) Pub. No.: US 2015/0278909 A1
(43) Pub. Date: Oct. 1, 2015

(54) TECHNIQUES FOR IMPROVING DIVERSITY AND PRIVACY IN CONNECTION WITH USE OF RECOMMENDATION SYSTEMS

(71) Applicant: Yahoo! Inc., Sunnyvale, CA (US)

(72) Inventor: Eric Bax, Sierra Madre, CA (US)

(73) Assignee: YAHOO! INC., Sunnyvale, CA (US)

(21) Appl. No.: 14/227,172

(22) Filed: Mar. 27, 2014

(51) Int. Cl. G06Q 30/06

(52) U.S. Cl. CPC G06Q 30/0631; G06Q 50/01

(57) ABSTRACT

Techniques are provided that include determining recommendations, of items, to be provided to users, based on information that may include social graph information. Techniques may be used prior to recommendation determination, or afterwards to modify initially determined recommendations. The techniques may improve diversity or privacy aspects associated with recommendations, such as by reducing duplication, or reducing effects of social grouping connections on recommendation determination or on initially determined recommendations.

### BACKGROUND

Recommendation systems may determine recommendations, such as of items, to be provided to users. A recommendation may be targeted, customized, optimized, or personalized to the user to whom it is directed, including determination of the item or items to be recommended. Social graph information may be used, and may be helpful, in determining a recommendation. However, determined recommendations may exhibit suboptimal diversity, such as with regard to the items recommended to users of a social group. Furthermore, determined recommendations may exhibit suboptimal privacy aspects. For example, a determined recommendation may evidence or hint, to a user, another user's interests, experiences, or preferences.

### SUMMARY

Some embodiments of the invention provide techniques, which may include programs, engines or algorithms, for determining recommendations, of items, to be provided to users, based on information that may include social graph information. Techniques may be employed prior to recommendation determination, or may be employed afterwards to modify initially determined recommendations. The techniques may improve diversity or privacy aspects associated with recommendations, such as by reducing duplication, or reducing effects of social grouping connections on recommendation determination or on initially determined recommendations.

### BRIEF DESCRIPTION OF THE DRAWINGS

FIG. 1 illustrates a block diagram of a distributed computer system that can implement one or more aspects of a recommendation or recommendation modification system or method according to one embodiment of the invention;

FIG. 2 illustrates a block diagram of an electronic device that can implement one or more aspects of a recommendation or recommendation modification system or method according to one embodiment of the invention; and

FIG. 3 illustrates a block diagram of a system that can implement one or more aspects of a recommendation or recommendation modification system or method according to one embodiment of the invention;

FIG. 4 illustrates a block diagram of a system that can implement one or more aspects of a recommendation or recommendation modification system or method according to one embodiment of the invention;

FIG. 5 illustrates a block diagram of a system that can implement one or more aspects of a recommendation or recommendation modification system or method according to one embodiment of the invention;

FIG. 6 illustrates a block diagram of a system that can implement one or more aspects of a recommendation or recommendation modification system or method according to one embodiment of the invention;

FIG. 7 illustrates a block diagram of a system that can implement one or more aspects of a recommendation or recommendation modification system or method according to one embodiment of the invention;

FIG. 8 illustrates a block diagram of a system that can implement one or more aspects of a recommendation or recommendation modification system or method according to one embodiment of the invention;

FIG. 9 illustrates a block diagram of a system that can implement one or more aspects of a recommendation or recommendation modification system or method according to one embodiment of the invention;

FIG. 10 illustrates a flow diagram of example operations of one or more aspects of a recommendation or recommendation modification system or method according to one embodiment of the invention;

FIG. 11 illustrates a flow diagram of example operations of one or more aspects of a recommendation or recommendation modification system or method according to one embodiment of the invention;

FIG. 12 illustrates a flow diagram of example operations of one or more aspects of a recommendation or recommendation modification system or method according to one embodiment of the invention; and

FIG. 13 illustrates a flow diagram of example operations of one or more aspects of a recommendation or recommendation modification system or method according to one embodiment of the invention.

While the invention is described with reference to the above drawings, the drawings are intended to be illustrative, and the invention contemplates other embodiments within the spirit of the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.”

It is noted that description herein is not intended as an extensive overview, and as such, concepts may be simplified in the interests of clarity and brevity.

It is noted that, in the figures, which unidirectional arrows may be depicted, in some embodiments, information may flow both ways, as would be represented by a bi-directional arrow.

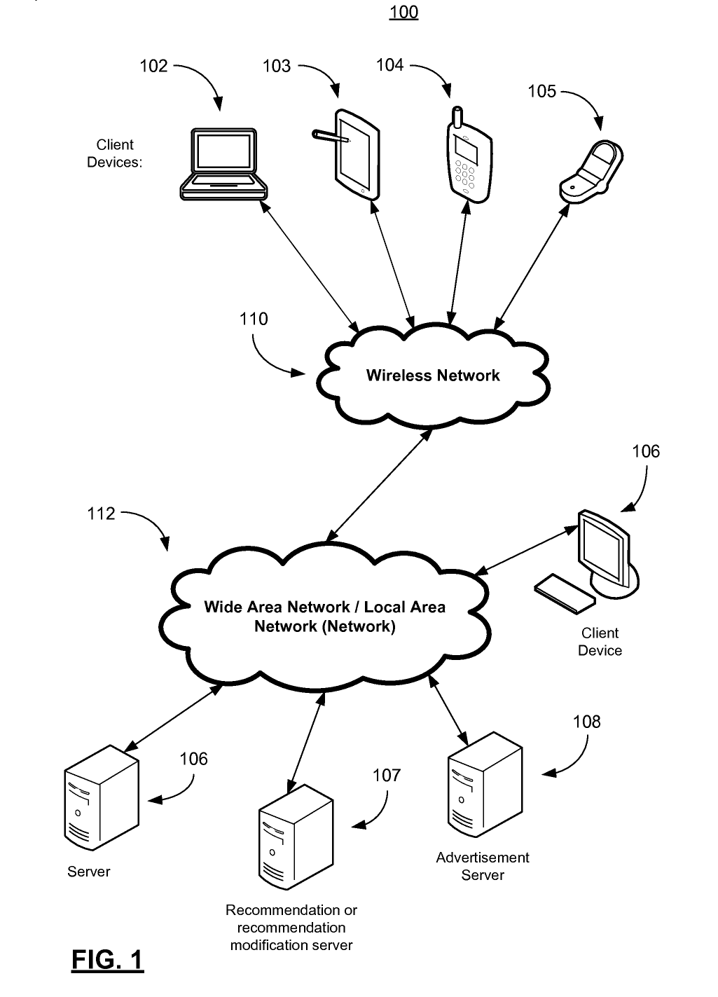

FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more local area networks (“LANs”)/wide area networks (“WANs”) 112, one or more wireless networks 110, one or more wired or wireless client devices 106, mobile or other wireless client devices 102-105, one or more servers 106, one or more recommendation or recommendation modification servers 107, and one or more advertisement servers 108, and may include or communicate with one or more data stores or databases. Various of the client devices 102-106 may include, for example, desktop computers, laptop computers, set top boxes, tablets, cell phones, smart phones, etc. The servers 106-108 can include, for example, one or more application servers, content servers, search servers, etc.

The system 100 also includes one or more advertisement servers 108 and one or more recommendation or recommendation modification servers 107. A server or servers 107, 108 can include, for example, a computer server that has a role in connection with recommendations, recommendation modifications, online advertising, or other roles. Such roles can for example, in whole or in part, creating, determining, modifying, constructing, in obtaining, storing, configuring, selecting, ranking, retrieving, targeting, matching, serving and presenting recommendations, modified recommendations, online advertisements, or other things to users, such as on websites, in applications, and other places where users will see them, receive them, have them be available, or have access to them. Recommendations or modified recommendations can include, among other things, recommendations to users, and recommendations of items to users, such as any of a broad variety of physical or non-physical things, entities, products, services, content, etc.

Herein, recommendations can be, include, or incorporate, in whole or in part, advertisements, and advertisements can be, include, or incorporate, in whole or in part, recommendations. Also, herein, discussions referring to advertisements or advertisements may also be applicable to recommendations, and vice versa, including, for example, selection, targeting, serving, and many other aspects. Furthermore, a recommendation can be a modified recommendation.

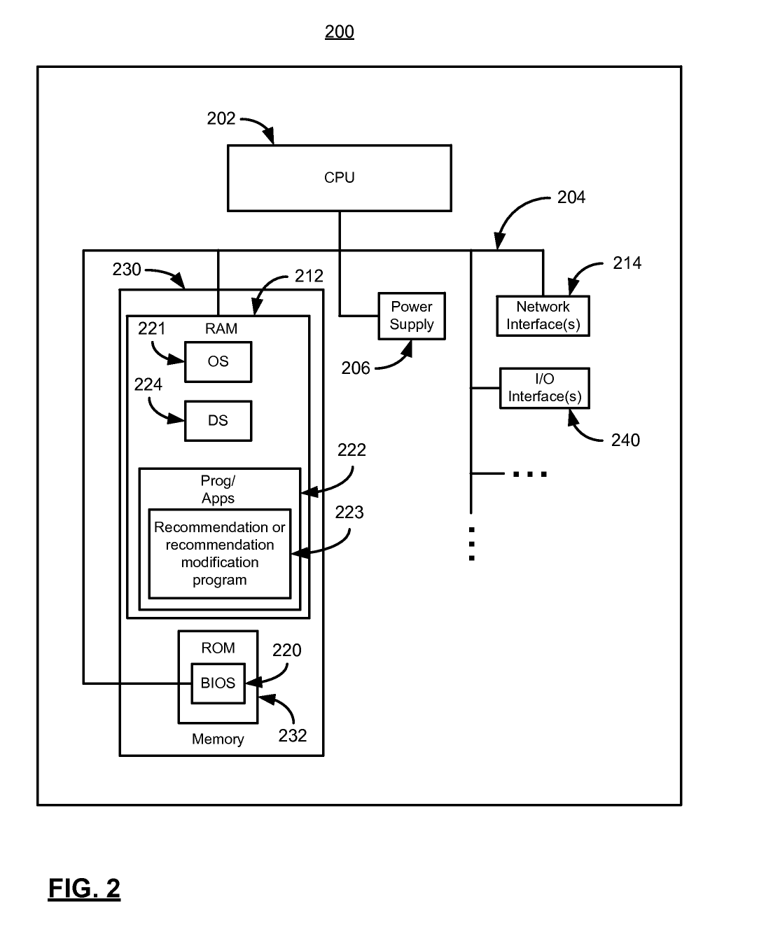

FIG. 2 illustrates a block diagram of an electronic device 200 that can implement one or more aspects of a recommendation or recommendation modification system or method according to one embodiment of the invention. Instances of the electronic device 200 may include servers, e.g. servers 106-108, and client devices, e.g. client devices 102-106. In general, the electronic device 200 can include a processor 202, memory 230, a power supply 206, and input/output (I/O) components 240, e.g., microphones, speakers, displays, touchscreens, keyboards, keypads, GPS components, etc., which may be operable, for example, to provide graphical user interfaces. The electronic device 200 can also include a communications bus 204 that connects the aforementioned elements of the electronic device 200. Network interfaces 214 can include a receiver and a transmitter (or transceiver), and an antenna for wireless communications.

The processor 202 can include one or more of any type of processing device, e.g., a central processing unit (CPU). Also, for example, the processor can be central processing logic. Central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software controlled microprocessor, discrete logic, e.g., an application specific integrated circuit (ASIC), a programmable/programmed logic device, memory device containing instructions, etc., or combinatorial logic embodied in hardware. Furthermore, logic may also be fully embodied as software.

The memory 230, which can include RAM 212 and ROM 232, can be enabled by one or more of any type of memory device, e.g., a primary (directly accessible by the CPU) or secondary (indirectly accessible by the CPU) storage device (e.g., flash memory, magnetic disk, optical disk). The RAM can include an operating system 221, data storage 224, which may include one or more databases, and programs and/or applications 222, which can include, for example, software aspects of the recommendation or recommendation modification program 223. The ROM 232 can also include BIOS 220 of the electronic device.

The recommendation or recommendation modification Program 223 is intended to broadly include or represent all programming, applications, algorithms, software and other tools necessary to implement or facilitate methods and systems according to embodiments of the invention. The elements of the recommendation or recommendation modification Program 223 may exist on a single server computer or be distributed among multiple computers or devices or entities, which can include advertisers, publishers, data providers, etc. Furthermore, an algorithm, as the term is used herein, can be or include, among other things, any of the types elements mentioned with regard the recommendation or recommendation modification program 223.

The power supply 206 contains one or more power components, and facilitates supply and management of power to the electronic device 200.

The input/output components, including I/O interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, and one or more input/output interfaces. A network care, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the recommendation or recommendation modification program 223, via a network to another device. Also, an application server may, for example, host a Web site that can provide a user interface for administration of example aspects of the recommendation or recommendation modification program 223.

Any computing device capable of sending, receiving, and processing data over a wired and/or a wireless network may act as a server, such as in facilitating aspects of implementations of the recommendation or recommendation modification program 223. Thus, devices acting as a server may include devices such as dedicated rack-mounted servers, desktop computers, laptop computers, set top boxes, integrated devices combining one or more of the preceding devices, etc.

Servers may vary in widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, etc.

A server may include, for example, a device that is configured, or includes a configuration, to provide data or content via one or more networks to another device, such as in facilitating aspects of an example recommendation or recommendation modification program 223. One or more servers may, for example, be used in hosting a Web site, such as the Yahoo! Web site. One or more servers may host a variety of sites, such as, for example, business sites, informational sites, social networking sites, educational sites, wikis, financial sites, government sites, personal sites, etc.

Servers may also, for example, provide a variety of services, such as Web services, third-party services, audio services, video services, email services, instant messaging (IM) services, SMS services, MMS services, FTP services, voice or IP (VOIP) services, calendaring services, phone services, advertising services etc., all of which may work in conjunction with example aspects of an example recommendation or recommendation modification program 223. Content may include, for example, text, images, audio, video, advertisements, recommendations, etc.

In example aspects of the recommendation or recommendation modification program 223, client devices may include, for example, any computing device capable of sending and receiving data over a wired and/or a wireless network. Such client devices may include desktop computers as well as portable devices such as cellular telephones, smart phones, display pagers, radio frequency (RF) devices, infrared (IR) devices, Personal Digital Assistants (PDAs), handheld computers, GPS-enabled devices tablet computers, sensor-equipped devices, laptop computers, set top boxes, wearable computers, integrated devices combining one or more of the preceding devices, etc.

Client devices, as may be used in an example recommendation or recommendation modification program 223, may range widely in terms of capabilities and features. For example, a cell phone, smart phone or tablet may have a numeric keypad and a few lines of monochrome LCD display on which only text may be displayed. In another example, a Web-enabled client device may have a physical or virtual keyboard, data storage (such as flash memory or SD cards), accelerometers, gyroscopes, GPS or other location-aware capability, and a 2D or 3D touch-sensitive color screen on which both text and graphics may be displayed.

Client devices, such as client devices 102-106, for example, as may be used in an example recommendation or recommendation modification program 223, may run a variety of operating systems, including personal computer operating systems such as Windows, iOS or Linux, and mobile operating systems such as iOS, Android, and Windows Mobile, etc. Client devices may be used to run one or more applications that are configured to send or receive data from another computing device. Client applications may provide and receive textual content, multimedia information, etc. Client applications may perform actions such as browsing webpages, using a web search engine, sending and receiving messages via email, SMS, or MMS, playing games (such as fantasy sports leagues), receiving advertising, watching locally stored or streamed video, or participating in social networks.

In example aspects of the recommendation or recommendation modification program 223, one or more networks, such as networks 110 or 112, for example, may couple servers and client devices with other computing devices, including through wireless network to client devices. A network may be enabled to employ any form of computer readable media for communicating information from one electronic device to another. A network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and a telephone link.

A wireless network, such as wireless network 110, as in an example recommendation or recommendation modification program 223, may couple devices with a network. A wireless network may employ stand-alone ad-hoc networks, mesh networks, Wireless LAN (WLAN) networks, cellular networks, etc.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, etc. Access technologies such as 2G, 2.5G, 3G, 4G, and future access networks may enable wide area coverage for client devices, such as client devices with various degrees of mobility. For example, wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, etc. A wireless network may include virtually any wireless communication mechanism by which information may travel between client devices and another computing device, network, etc.

Internet Protocol may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), wide area networks (WANs), wireless networks, and long haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

A “content delivery network” or “content distribution network” (CDN), as may be used in an example recommendation or recommendation modification program 223, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's Web site infrastructure, in whole or in part, on the third party's behalf

A peer-to-peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Some embodiments include direct or indirect use of social networks and social network information, such as in targeted advertising, recommendation determination, selection, etc. A “Social network” can include, among other things, a network of acquaintances, friends, family, colleagues, and/or coworkers, and potentially the subsequent connections within those networks. A social network, for example, may be utilized to find more relevant connections for a variety of activities, including, but not limited to, dating, job networking, receiving or providing service referrals, content sharing, creating new associations or maintaining existing associations with like-minded individuals, finding activity partners, performing or supporting commercial transactions, etc.

A social network may include, among other things, individuals with similar experiences, opinions, education levels and/or backgrounds, or may be organized into subgroups according to user profile, where a member may belong to multiple subgroups. A user may have multiple “1:few” circles, such as their family, college classmates, or coworkers.

A person's online social network can include, among other things, the person's set of direct relationships and/or indirect personal relationships. Direct personal relationships can include, among other things, relationships with people the user communicates with directly, which may include family members, friends, colleagues, coworkers, and the like. Indirect personal relationships refers to people with whom a person has not had some form of direct contact, such as a friend of a friend, or the like. Different privileges and permissions may be associated with those relationships. A social network may connect a person with other people or entities, such as companies, brands, or virtual persons. A person's connections on a social network may be represented visually by, for example, a graph that represents each entity as a node and each relationship as an edge.

A “social graph”, as the term is used herein, can broadly include, among other things, for example, for a user, or among or between people or users, indirect or direction information, indications, or representations of, indirect or direct connections, relationships, associations, groupings, grouping information, commonalities, contacts, similarities or differences, shared characteristics, features, tags, interests, or preferences, which can include scores, weighting, degrees, strength or weakness, etc.

Users may interact with social networks through a variety of devices. Multi-modal communications technologies may enable consumers to engage in conversations across multiple devices and platforms, such as cell phones, smart phones, tablet computing devices, personal computers, televisions, SMS/MMS, email, instant messenger clients, forums, and social networking sites (such as Facebook, Twitter, and Google+), or others.

In some example recommendation or recommendation modification programs 223, various monetization techniques or models may be used in connection with contextual or non-search related advertising, as well as in sponsored search advertising, including advertising associated with user search queries, and non-sponsored search advertising, including graphical or display advertising, or in connection with recommendations or modified recommendations. In an auction-based online advertising marketplace, advertisers may bid in connection with placement of advertisements, although many other factors may also be included in determining advertisement selection or ranking Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

The process of buying and selling online advertisements may include or require the involvement of a number of different entities, including advertisers, publishers, agencies, networks, and developers. To simplify this process, some companies provide mutual organization systems called “ad exchanges” that connect advertisers and publishers in a unified platform to facilitate the bidded buying and selling of online advertisement inventory from multiple ad networks. “Ad networks” refers to companies that aggregate ad space supply from publishers and provide en masse to advertisers.

For Web portals, such as Yahoo!, advertisements may be displayed on web pages resulting from a user-defined search based upon one or more search terms. Such advertising is most beneficial to users, advertisers and web portals when the displayed advertisements are relevant to the web portal user's interests. Thus, a variety of techniques have been developed to infer the user's interests/intent and subsequently target the most relevant advertising to that user.

One approach to improving the effectiveness of presenting targeted advertisements to those users interested in receiving product information from various sellers is to employ demographic characteristics (i.e., age, income, sex, occupation, etc.) for predicting the behavior of groups of different users. Advertisements may be presented to each user in a targeted audience based upon predicted behaviors rather than in response to certain keyword search terms.

Another approach is profile-based ad targeting. In this approach, user profiles specific to each user are generated to model user behavior, for example, by tracking each user's path through a web site or network of sites, and then compiling a profile based on what pages and advertisements were delivered to the user. Using aggregated data, a correlation develops between users in a certain target audience and the products that those users purchase. The correlation then is used to target potential purchasers by targeting content or advertisements to the user at a later time.

During the presentation of advertisements, the presentation system may collect detailed information about the type of advertisements presented to the user. This information may be used for gathering analytic information on the advertising or potential advertising within the presentation. A broad range of analytic information may be gathered, including information specific to the advertising presentation system. Advertising analytics gathered may be transmitted to locations remote to the local advertising presentation system for storage or for further analysis. Where such advertising analytics transmittal is not immediately available, the gathered advertising analytics may be saved by the advertising presentation system until the transmittal of those advertising analytics becomes available.

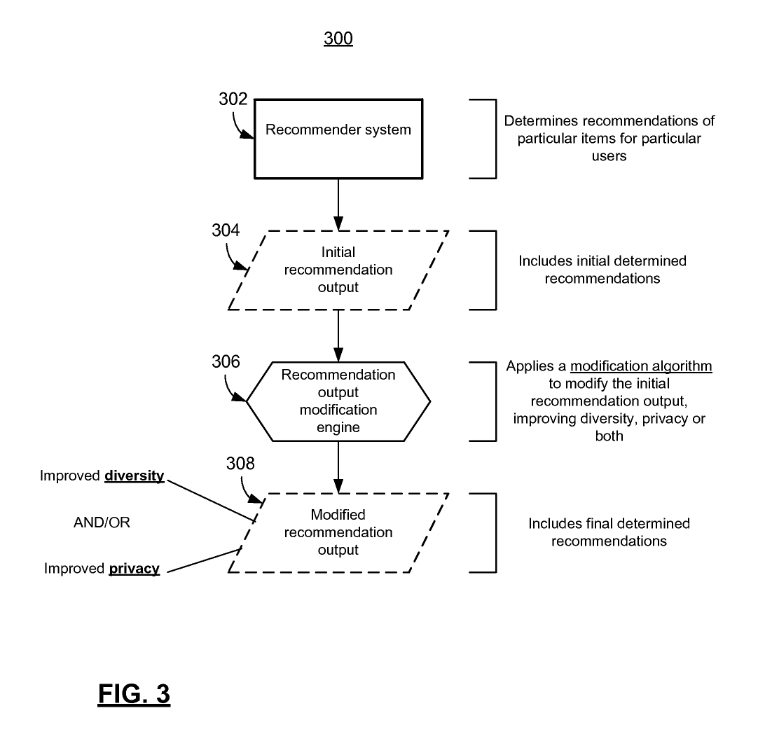

FIG. 3 illustrates a block diagram of a system 300 that can implement one or more aspects of a recommendation or recommendation modification system or method according to one embodiment of the invention. Block 302 represents a recommender system, which determines recommendations of particular items for particular users.

Block 304 represents initial recommendation output, which includes initial determined recommendations, from the recommender system 302.

Block 306 represents a recommendation output modification engine, which applies a modification algorithm to modify the initial recommendation output, improving diversity, privacy or both.

Block 308 represents the modified recommendation output, which includes final determined recommendations with improved diversity, privacy or both, such as relative to the recommendation output, or recommendations thereof, prior to modification.

As the term is used herein, “diversity”, in connection with recommendation output or recommendations, generally refers to the degree of variety in items recommended, such as to members of a social group. As one or many possible examples and particular interpretations, in some embodiments, with respect to a set of a certain number of determined recommendations, each recommendation to one user and of one item or type of item, to users in a particular social group, diversity may be considered to be higher if the number of items, or types of items, recommended is higher. So, in some embodiments, in the foregoing example, if the specifics happen to include a set of three recommendations, each to a different user in the social group and each of a different item, then a set consisting of three recommendations of three different items (three recommended items, total) may be considered to have greater diversity than a set consisting of two recommendations of the same item, and one recommendation of a different item (two recommended items, total). Of course, many different examples and specific interpretations are possible.

As the term is used herein, “privacy”, in connection with recommendation output or recommendations, may refer to avoidance, or a degree of avoidance, of recommendations that may evidence or hint, to the subject users (the users to whom they are directed) another user or users whose characteristics, such as interests, possessions or experiences, may have led to the recommendation being directed to the subject user. For example, privacy may refer to avoidance, or the degree of avoidance, for each particular recommendation, for example, of an item, evidence, to the subject user (the user to whom the recommendation of the item is directed), of a specific other user, or specific set of other users, in the social group, whose characteristics, such as interest(s), preference(s), possession(s), experience(s), etc., may have led, at least in part, to the recommendation of item being directed to the first user. Privacy may be measured or quantified in any of various ways, such as including reference to, or particular weighting of, for a set of recommendations, the number of such recommendations which provide such evidence, the degree of strength of the evidence for each such recommendation, etc.

As a more concrete, but simplified, example demonstrating the privacy concept or issue, suppose there is a social group of users, Social Group A. Further suppose that this is a small group, and each of the users knows each of the others. Further suppose that, of this group, User 1 is the only user known to be an action movie fan. Further suppose that User 2 receives a recommendation of Movie A, an action movie. The recommendation itself, to User 2, may evidence to User 2 that the recommendation may have been caused, at least in part, by a possible interest, preference, experience, etc., of User 1, given User 1's interest in action movies. As such, User 2 may suspect that User 1 perhaps has an interest in, or experience with, Movie A. If this is true, User 1 may not have expected his or her interest in Movie A to be evidenced (or exposed, hinted at, etc.), even if unintentionally or indirectly, to User 2. Privacy may be considered to some degree compromised or lessened. Of course, for simplicity, many details are left out of the foregoing example. Furthermore, many other examples and interpretations are possible.

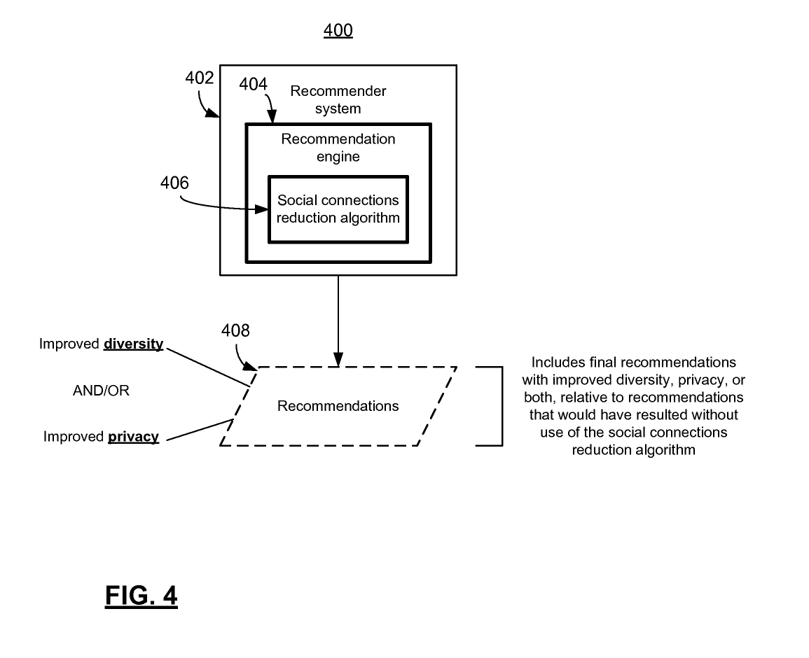

FIG. 4 illustrates a block diagram of a system 400 that can implement one or more aspects of a recommendation or recommendation modification system or method according to one embodiment of the invention. Block 402 represents a recommender system, which includes a recommendation engine 404. The recommendation engine includes a social connections reduction algorithm 406.

Block 408 represents recommendations 408, including final recommendations with improved diversity, privacy, or both, relative to recommendations that would have resulted without use of the social connections reduction algorithm.

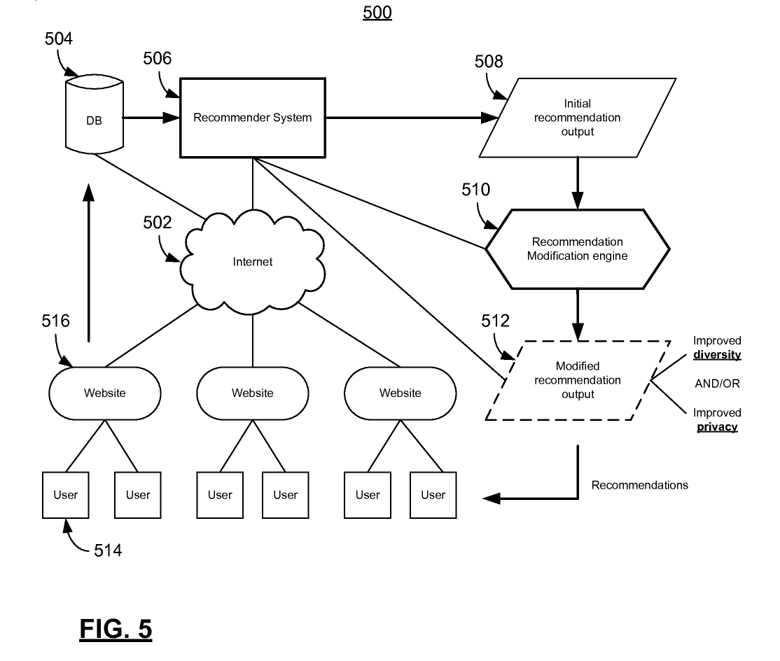

FIG. 5 illustrates a block diagram of a system 500 that can implement one or more aspects of a recommendation or recommendation modification system or method according to one embodiment of the invention. Various users 514 and depicted in association with various Web sites 516, which are connected, directly or indirectly, to the Internet 502. Various of the users 514 may, for example, be browsing, or have browsed, the Web sites 516. Information about users and user activities on Web sites, which can, for example, among other things, explicitly or implicitly indicate user preferences or interests, such as in connection with items, as well as social graph information, can be part of the information sent, directly or indirectly, and stored in the database 504.

Block 504 represents one or more databases, which may store information including, among other things, various user information, user preference or interest information, social graph information, and information relating to items.

Block 506 represents a recommender system, which, among other things, receives (and may also send) information to the database 504.

Block 508 represents initial recommendation output from the recommender system 506.

Block 510 represents a recommendation modification engine, which produces or is used to produce modified recommendation output 512 with improved diversity and/or improved privacy, such as relative to the initial recommendation output 508.

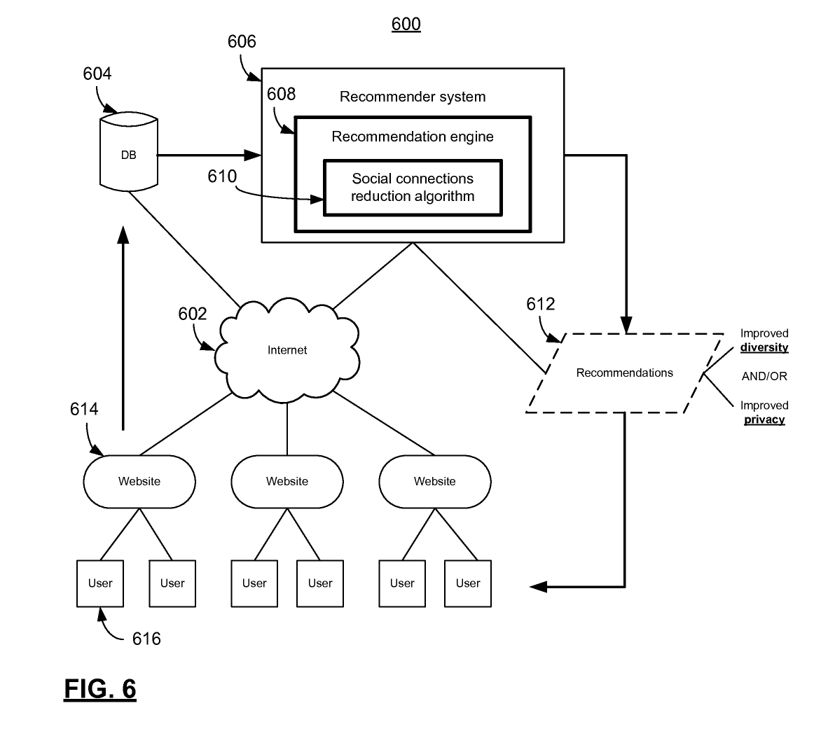

FIG. 6 illustrates a block diagram of a system 600 that can implement one or more aspects of a recommendation or recommendation modification system or method according to one embodiment of the invention. A number of the elements depicted in FIG. 6 are similar in some ways to elements depicted in FIG. 5, including users 616, Websites 614, the Internet 602, and one or more databases 604.

Block 606 represents a recommender system, including a recommendation engine 608 that includes a social connections reduction algorithm 610. Prior to determination of recommendation output or recommendations, the social connections reduction algorithm 610 is used, for example, for the purposes of recommendation determination, to reduce or eliminate, or reduce or elimination the effect of, social group connections, such as for one or more social groups.

Block 612 represents recommendations, or recommendation output, in which the recommendations have improved diversity and/or improved privacy, such as relative to recommendations that might have been determined without use of the social connections reduction algorithm prior to recommendation determination.

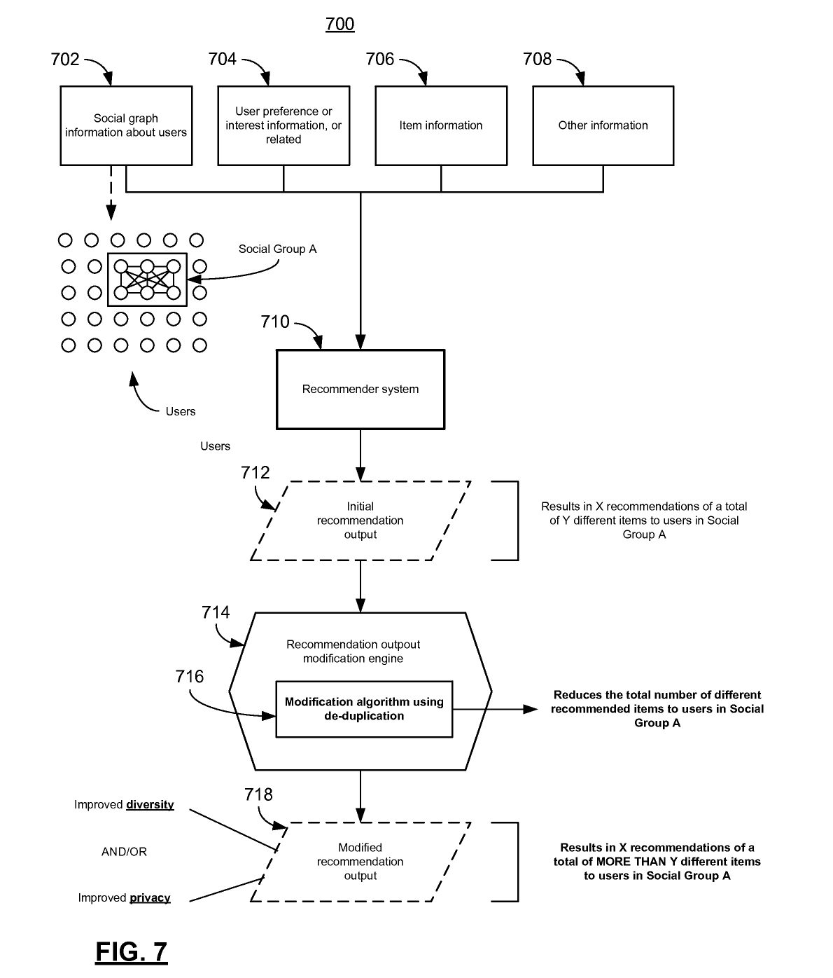

FIG. 7 illustrates a block diagram of a system 700 that can implement one or more aspects of a recommendation or recommendation modification system or method according to one embodiment of the invention. Block 710 represents a recommender system. Various information may be received by the recommender system 710, including social graph information about users 702, user preference or interest information, or related 704, item information 706, and other information 708.

The social graph information 702 is conceptually depicted by circles, each representing, for example, a user, including Social Group A, which, as depicted, includes six users. As depicted, the position of the circles is not meant to imply nearness or relationship, but only to demonstrate that, among the users represented in the social graph (some or all of which may be connected with others), a subset thereof is identified as a social group, Social Group A. The lines connecting each of the users in Social Group A are intended only to represent that each of them is associated with each of the others at least by virtue of their belonging to Social Group A, and even if they have no connection to each other individually, other than their mutual belonging in Social Group A.

Herein, the term “social group” is intended to be broadly construed to include various types of sets of socially connected or socially associated users. A social group may be explicit, implied, or determined based on various information, which can include express or implied membership, user behavior, history, user profiles, user demographics, geography, communications, social networking or other group communications or associations, etc. Various types of social groups may include various types and degrees of connections between some, or all, of the users therein.

The recommendation system 710, uses the information 702-708 in determination of initial recommendation output 712. The initial recommendation output 712 results in a number, X, of recommendations of a total of a number, Y, different items to users in social group A. Of course, the recommendation output may also include other recommendations, there may be other social groups, etc., which, for simplicity, are not specifically described FIG. 7.

Block 714 represents a recommendation modification engine, which includes, in the embodiment depicted, a modification algorithm using de-duplication 716, which, by application to the initial recommendation output, reduces the total number of different recommended items to users in Social Group A. Block 718 represents the resulting modified recommendation output, which includes X recommendations of a total of more than Y different items to users in Social Group A. In some embodiments, this is considered to increase diversity. Furthermore, privacy may, in some instances or implementations, also be increased.

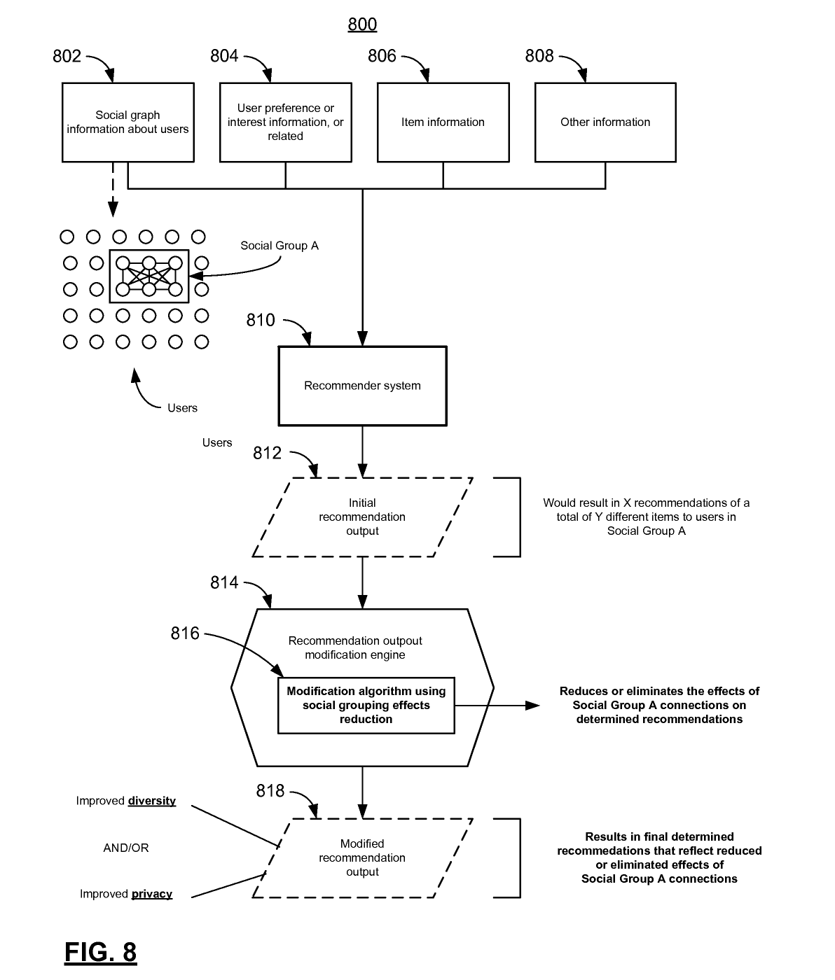

FIG. 8 illustrates a block diagram of a system 800 that can implement one or more aspects of a recommendation or recommendation modification system or method according to one embodiment of the invention. Some elements of the system 800 are in some ways similar to elements of system 700 depicted in FIG. 7, including various information 802-808, recommender system 810, and initial recommendation output 812.

As depicted in FIG. 8, however, recommendation output modification engine 814 includes a modification algorithm using social grouping effects reduction 816, which, in the embodiment depicted, reduces or eliminates the effects of Social Group A connections, or some of them, on determined recommendations. This results in modified recommendation output 818, which includes final determined recommendations that reflect reduced or eliminated effects of Social Group A connections.

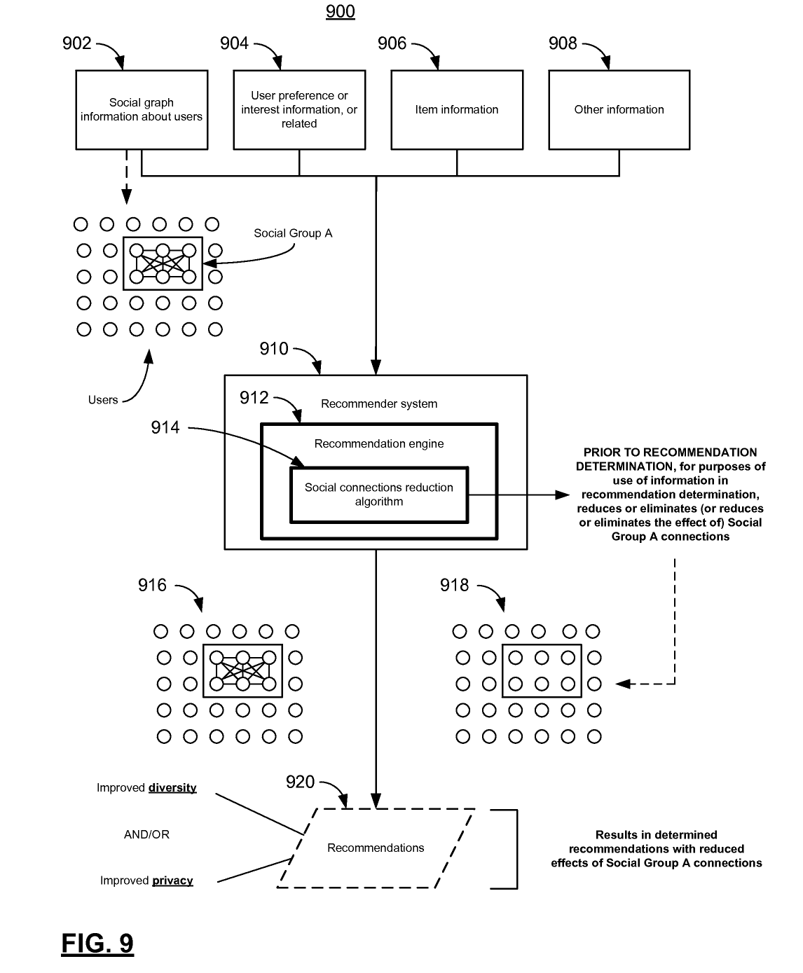

FIG. 9 illustrates a block diagram of a system 900 that can implement one or more aspects of a recommendation or recommendation modification system or method according to one embodiment of the invention. Some elements are the system 900 are in some ways similar to the system 800 as depicted in FIG. 8, including the various information 902-908.

However, recommender system 910 includes a recommendation engine 912 that includes a social connections reduction algorithm 914, which, for purposes of use of information in recommendation determination, reduces or eliminates (or reduces or eliminates the effect of) Social Group A connections. This is depicted, in a simplified, conceptual way, by feature 916, representing, for purposes of recommendation determination, Social Group A before operation of the social connections reduction algorithm 914, and feature 918, representing, for purposes of recommendation determination, Social Group A after operation of the social connections reduction algorithm 914, with some or all Social Group A connections removed (for purposes of the information as used in recommendation determination).

Block 920 represents determined recommendations. Recommendation determination, following use of the social connections reduction algorithm 914, results in determined recommendations, or recommendation output, with reduced or eliminated effects of Social Group A connections. This may improve diversity, privacy, or both, relative to operation of the recommendation engine without use of the social connections reduction algorithm 914. In some embodiments, by removing the social connections before recommendation determination, both diversity and privacy are improved.

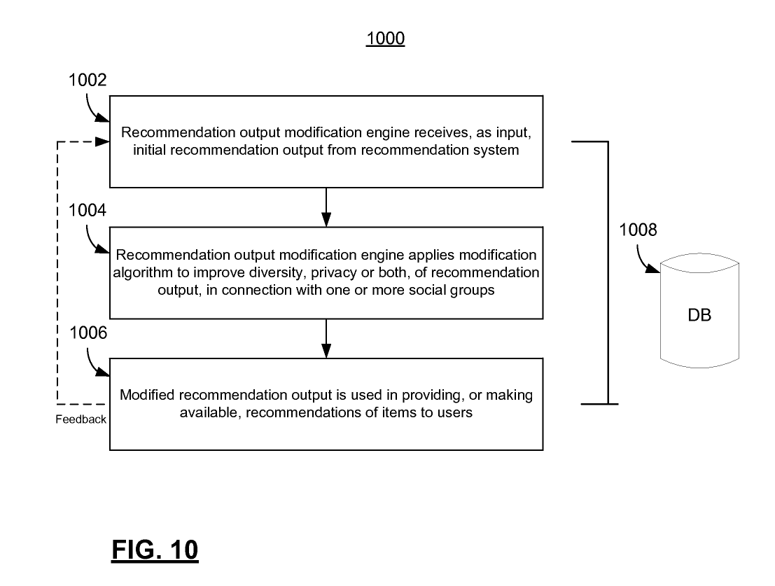

FIG. 10 illustrates a flow diagram 1000 of example operations of one or more aspects of a recommendation or recommendation modification system or method according to one embodiment of the invention, including use of recommendation output, or modified recommendation output as feedback for later recommendation determination.

Step 1002 includes a recommendation output modification engine receiving (or obtaining), as some input, initial recommendation output from a recommendation system.

Step 1004 includes the recommendation output modification engine applying a modification algorithm to improve the diversity, privacy, or both, of recommendation output, in connection with one or more social groups. It is noted that, in some embodiments, diversity or privacy may alternatively or also be improved for a set of users beyond any particular social groups, or all users, etc.

Step 1006 includes use of modified recommendation output, resulting from step 1004, in providing, or making available, recommendations to users, which may have improved diversity, privacy, or both. Furthermore, information relating to the provided recommendations, as well as user behavior, including downstream behavior such as clicks, purchases, sharing, etc., is tracked, stored in one or more databases 1008. The information may be utilized in data mining, optimization, or as some input in later recommendation determination, such as by being used in formulating profiles of users or items, constructing models such as machine learning models, in optimization algorithms, etc.

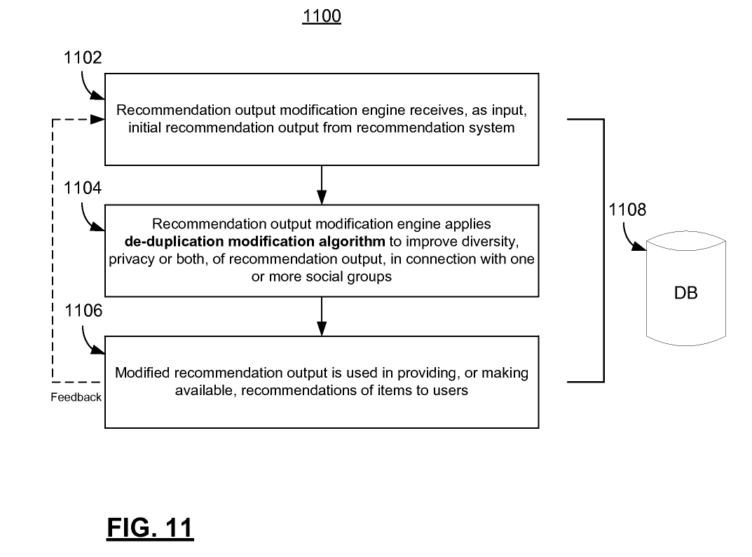

FIG. 11 illustrates a flow diagram 1100 of example operations of one or more aspects of a recommendation or recommendation modification system or method according to one embodiment of the invention, including use of recommendation output, or modified recommendation output as feedback for later recommendation determination.

Step 1102 includes a recommendation output modification engine receiving (or obtaining), as some input, initial recommendation output from a recommendation system.

Step 1104 includes the recommendation output modification engine applying a de-duplication modification algorithm to improve the diversity, privacy, or both, of recommendation output, in connection with one or more social groups.

Step 1106 includes use of modified recommendation output, resulting from step 1104, in providing, or making available, recommendations to users, which may have improved diversity, privacy, or both. Furthermore, information relating to the provided recommendations, as well as user behavior, including downstream behavior such as clicks, purchases, sharing, etc., is tracked, stored in one or more databases 1108. The information may be utilized in data mining, optimization, or as some input in later recommendation determination, such as by being used in formulating profiles of users or items, constructing models such as machine learning models, in optimization algorithms, etc.

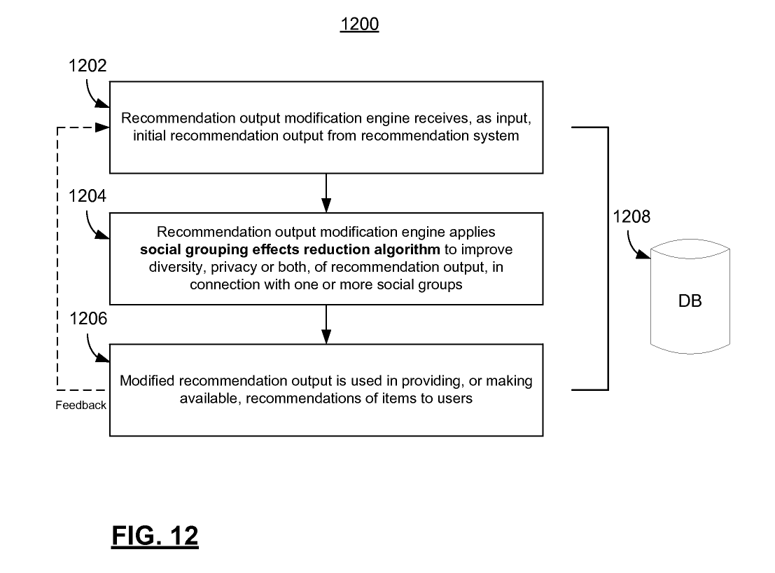

FIG. 12 illustrates a flow diagram 1200 of example operations of one or more aspects of a recommendation or recommendation modification system or method according to one embodiment of the invention, including use of recommendation output, or modified recommendation output as feedback for later recommendation determination.

Step 1202 includes a recommendation output modification engine receiving (or obtaining), as some input, initial recommendation output from a recommendation system.

Step 1204 includes the recommendation output modification engine applying a social grouping effects reduction algorithm to improve the diversity, privacy, or both, of recommendation output, in connection with one or more social groups.

Step 1206 includes use of modified recommendation output, resulting from step 1204, in providing, or making available, recommendations to users, which may have improved diversity, privacy, or both. Furthermore, information relating to the provided recommendations, as well as user behavior, including downstream behavior such as clicks, purchases, sharing, etc., is tracked, stored in one or more databases 1208. The information may be utilized in data mining, optimization, or as some input in later recommendation determination, such as by being used in formulating profiles of users or items, constructing models such as machine learning models, in optimization algorithms, etc.

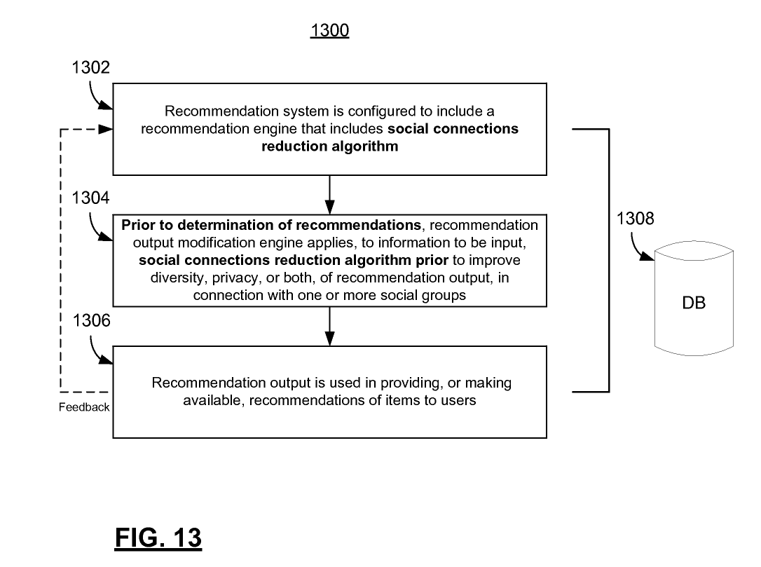

FIG. 13 illustrates a flow diagram 1300 of example operations of one or more aspects of a recommendation or recommendation modification system or method according to one embodiment of the invention, including use of recommendation output, or modified recommendation output as feedback for later recommendation determination.

At step 1302, a recommendation system is configured to include a, including a recommendation engine that includes a social connections reduction algorithm.

Step 1304 includes, prior to determination of recommendations, a recommendation output modification engine applying, to information to be input, the social connections reduction algorithm to improve the diversity, privacy, or both, of recommendation output, in connection with one or more social groups.

Step 1306 includes use of modified recommendation output, resulting from step 1304, in providing, or making available, recommendations to users, which may have improved diversity, privacy, or both. Furthermore, information relating to the provided recommendations, as well as user behavior, including downstream behavior such as clicks, purchases, sharing, etc., is tracked, stored in one or more databases 1308. The information may be utilized in data mining, optimization, or as some input in later recommendation determination, such as by being used in formulating profiles of users or items, constructing models such as machine learning models, in optimization algorithms, etc.

Some embodiments include, in whole or in part, excluding, removing or reversing for aspects of socially connected user preferences or interest on recommendations, such as to promote diversity or privacy. For example, some embodiments help promote maximum variation in recommendations to socially connected users, and help protect against suggesting or revealing user preferences or interests to other users. Some embodiments can be viewed as promoting good qualities of receiving “advice from a stranger” or “similar strangers”. Furthermore, some embodiments promote giving individuals in a particular social group different experiences, so that everyone has a better chance of having something new to contribute or share.

It is noted that various modification algorithms are described in connection with various embodiments, such as embodiments in which the algorithm is part of, or not part of, the recommender system itself, and embodiments that include operation before, or after, determination or recommendations or initial determination of recommendations. However, other combinations, even if not specifically included in the description, are contemplated.

Some embodiments of the invention are for use in or with recommendation systems, such as collaborative filtering recommendation systems, which may derive recommendations for particular users based in part on data about the user and data about other users. The recommendations may be for items, which may be or include, for example, internet content, films, books, products, services, or other things. Various types of recommendations may be determined to recommend a single or multiple items per user, and to present them to the user for possible consumption, or for the user to consider for purchase, or for other reasons. Collaborative filtering may be based on a variety of data about users and about items, for example.

Since collaborative filtering systems may use the preferences of some users to recommend items to other users, collaborative filtering systems may, for example, expose or hint at information about some users' preferences to other users. Even if the collaborative filtering system does not expose the identities of users to other users, users may be able to guess the identities of the fellow users that prompted recommendation of some items, for example, if the users already have a social connection to those fellow users. This can lead to a loss of or reduction in privacy.

In addition to users potentially not wanting their preferences revealed or suggested to fellow users with whom they have a social connection, users may prefer recommendations for items that users in their social circle do not already prefer or have not already received or experienced. For example, a significant goal of some recommendation systems is to introduce users to novel items, and users are more likely to have already been exposed to items that their social connections prefer. Simply put, users may have a preference to discover items that are novel to their social circle as well as to themselves.

Some embodiments of the invention provide systems and methods that may, among other things, reduce the probability that recommendations for a user are based on data about users to whom they are socially connected. One method may include, for recommendation determination purposes, removing users, or some or all connections, or aspects of connections, relating to the users, who have social connections to a user, from the process of recommending items to that user. Another method may include, for example, modifying or correcting for the influence of users who have social connections to a user after the process of applying a recommendation system to determine recommendations of items for that user, before the recommendations are finalized, utilized, or shared with the user.

In some collaborative filtering systems, recommendations for a user are based on data about the user's nearest neighbors among other users. The metric to determine nearest neighbors may be based on data about users, including their preferences, interests, similarities, etc. For example, to determine recommendations for a user, a system may identify the k other users with the preferences most similar to the user, then use their preferences in determining recommendations for the user, where k is a pre-specified parameter, such as a number. Alternatively, the system may identify a set of other users within some pre-specified distance of the user, under the system's metric. In either case, the search for neighbors may be approximate, since, to gain in speed or to increase randomness of recommendations, the system may not need to identify exactly the set of specified neighbors, but can instead identify a set that approximates it.

In a nearest neighbors collaborative filtering system, techniques according to some embodiments of the invention remove, or remove in part, for recommendation determination purposes, neighbors that are socially connected to the user before determining recommendations for the user. In some embodiments, a way to do this is to collect social graph information, for example, with nodes that represent users and edges that represent social connections between users. For each user, the social graph may be used in identifying the set of their social connections (users with whom the user is connected by an edge in the graph). After the collaborative filtering system identifies nearest neighbors for a user (which involved in recommendations for the user), some embodiments include removal of any, or some, neighbors that are in the user's set of social connections from the nearest neighbor set before determining recommendations.

Furthermore, variations according to some embodiments may treat, as social connections, not just direct or “one hop” connections, but any user within h hops of the user for whom a recommendation or recommendations are being derived, where h is a pre-specified parameter, such as a number. Also, some variations avoid using the same recommendation-related user, or user in a social graph that is associated with a recommendation to another user, for multiple users that are in a social group, which can help ensure that users who know each other receive different recommendations, or recommendations of different items.

Some collaborative filtering systems cluster or otherwise combine data about users, items, or both. In some embodiments, in or with some such systems, it may not be feasible to remove each user's social connections and re-compute the combined recommendations separately for each user. Furthermore, even for some nearest neighbors systems, in some embodiments, it may be desirable to correct rather than remove social connections, such as, for example, to ensure or help ensure that the recommendations of social connections are not present in recommendations by other recommendation-related users just by chance. In some embodiments, in cases such as these, modification or correction can be made after initial recommendation determination, but before final recommendation determination, where final recommendations may be, for example, those recommendations actually planned to be shared, or in fact shared, with users.

For example, in some embodiments, recommendations may be determined with or by a collaborative filtering recommendation system. Social connections may be identified or collected for each user. Following this, some embodiments may include estimating the impact that the social connections had on the recommendation(s), and reversing that impact. Alternatively, some embodiments include deriving initial recommendations based specifically or in a limited fashion on the data about social connections, and then subtracting, partially subtracting, or de-emphasizing those from the initial recommendations that resulted from the overall collaborative filtering technique.

Some embodiments use recommendation system results for a user's social connections to de-emphasize or remove those recommendations from the recommendations that the system offers for a user. If the system determines the same items to recommend for multiple users who are socially connected, then it may determine to present those items to one of those users, or at least to fewer of them, or an algorithmically and optimally chosen fewer of them, to increase recommendation diversity for a socially connected set of users.

Some embodiments use modification algorithms that use de-duplication, aspects of which are specifically depicted, for example, in FIGS. 7 and 10. In some embodiments, in addition to de-duplication, for example, with respect to multiple recommendations of the same item, instances in which it is determined that a user has experienced (or owned, etc.) an item may be treated as, or similar to, an instance similar to a recommendation of the item, so that even a single recommendation of the item to that user, or perhaps to any user in an associated social group, will be avoided.

Furthermore, some embodiments of the invention may utilize or incorporate strength or scores of matching or pairing, of users and items, in connection with modification of sets of recommendations or recommendation output. For example, a high user/item score may indicate a higher probability of interest of the user in the item. In some embodiments, if recommendations are eliminated, such as, for example, through the user of a de-duplication modification algorithm or other modification algorithm, a higher user/item score may lead to a preference to keep a recommendation of that item to that user, whereas a lower user/item score may lead to a preference or greater probability of eliminating a recommendation of that item to that user. Algorithms, such as modification algorithms, may, for example, utilize optimization algorithms with constraints, such as to implement the foregoing. Furthermore, various types of optimization algorithms, which may include constraints of various types, may be used as, or as part of, some embodiments of modification algorithms or engines, for example.

Various embodiments of the invention may be used with or in various types of recommender systems, including, without limitation, systems that use, or use various combinations or elements of, data mining, statistical analysis, compression, approximation, optimization, constraint sets, collaborative filtering, nearest neighbor algorithms, feature sets, modeling, machine learning, matrices, matrix multiplication, matrix reduction, principal component analysis, and others.

While the invention is described with reference to the above drawings, the drawings are intended to be illustrative, and the invention contemplates other embodiments within the spirit of the invention.

1. A system, for use with or in a recommendation system that determines recommendations of items to particular users based on information, including user preference or user interest information, from multiple users, the system comprising one or more processors and a non-transitory storage medium comprising program logic for execution by the one or more processors, the program logic comprising:
a recommendation output modification engine, that:
receives, as a source of input, recommendation output, from the recommendation system, including determined recommendations for particular users of a set of users; and
applies a modification algorithm to modify the recommendation output to produce modified recommendation output, at least to improve, relative to the recommendation output, the diversity of recommendations within at least one social group that includes at least some of the set of users,
wherein the modified recommendation output is for use by the recommendation system in determining recommendations to users of the set of users.

2. The system of claim 1, wherein the modification algorithm, utilizes, as at least some sources of input, social graph information about at least some of the set of users, and user preference or user interest information about at least some of the set of users.

3. The system of claim 1, comprising applying the modification algorithm, wherein the modification algorithm, utilizes, as at least some sources of input, social graph information about at least some of the set of users, and user preference or user interest information about at least some of the set of users, as well as information about features of items.

4. The method of claim 1, comprising the recommendation output modification engine providing the modified recommendation output to the recommendation system for use in determining recommendations to users of the set of users.

5. The system of claim 1, wherein diversity is improved if, for a certain number of recommendations, each recommending an item, to users of a first social group, the number of different recommended items is increased.

6. The system of claim 1, wherein diversity is improved at least in part by removing, or reducing the instances of, duplication of particular recommended items to any of the users that are part of the social group.

7. The system of claim 1, wherein diversity is improved at least in part by utilizing, as at least part of the modification algorithm, an optimization algorithm that utilizes diversity-improving constraints relating to recommendations of items to users in a social group.

8. The system of claim 1, wherein diversity is improved at least in part by removing, or reducing the instances of, duplication of particular recommended items to any of the users that are part of the social group, and wherein, in removing or reducing instances of duplication of particular recommended items to any users that are part of the social group, the modification algorithm utilizes an optimization algorithm that implements a preference to remove instances in which a user-item pairing is weaker, as opposed to removing instances in which a user-item pairing is stronger.

9. The system of claim 1, wherein the recommendation system includes a recommendation algorithm.

10. The system of claim 1, wherein the recommendation system includes a recommendation algorithm that utilizes collaborative filtering.

11. The system of claim 1, wherein the recommendation system includes a recommendation algorithm that utilizes a nearest neighbor algorithm.

12. The system of claim 1, wherein the recommendation system includes a recommendation algorithm that utilizes clustering.

13. The system of claim 1, wherein the recommendation system includes a recommendation algorithm that utilizes machine learning.

14. The system of claim 1, comprising applying the modification algorithm, wherein applying the modification algorithm improves, relative to the recommendation output, the privacy of recommendations within at least one social group that includes at least some of the set of users.

15. The system of claim 1, comprising applying the modification algorithm, wherein application of the modification algorithm improves, relative to the recommendation output, the privacy of recommendations within at least one social group that includes at least some of the set of users, and wherein privacy is improved if, for a set of recommendations to users in a social group, fewer recommendations are evidenced as being at least in part a result, or likely at least in part a result, of a preference or interest of a particular, identifiable user in the social group.

16. The system of claim 1, comprising applying the modification algorithm, wherein application of the modification algorithm eliminates or reduces an effect of social group connections on determined recommendations.

17. A method comprising:
a recommendation engine receiving, as a source of input, information, including user preference or user interest information, about multiple users;
the recommendation engine receiving, as a source of input, social graph information about at least some of the multiple users, including at least a first social group including at least some of the multiple users;
the recommendation engine, prior to applying a recommendation algorithm, applying a social connections reduction algorithm to at least some of the social graph information to generate reduced connections social graph information, wherein the social connections reduction algorithm removes at least some social group connections that are part of the first social group; and
the recommendation engine applying the recommendation algorithm to determine recommendations of items to users including at least some of the multiple users, comprising utilizing the reduced connections social graph information instead of the social graph information.

18. The method of claim 17, comprising the recommendation applying a recommendation algorithm to determine recommendations of items to users including at least some of the set of users, comprising utilizing the reduced connections social graph information instead of the social graph information, so that an effect of social group connections on determined recommendations is reduced relative to an effect of social group connections on determined recommendations that would have occurred if the social graph information was utilized instead of the reduced connections social graph information.

19. The method of claim 17, comprising the recommendation engine applying the recommendation algorithm to determine recommendations of items to users including at least some of the multiple users, wherein utilizing the reduced connections social graph information instead of the social graph information improves both the diversity and the privacy of recommendations determined by the recommendation engine.

20. A non-transitory computer readable storage medium or media tangibly storing computer program logic capable of being executed by a computer processor, the program logic comprising a recommendation output modification engine for:
obtaining, as a source of input, recommendation output, from a recommendation system, including determined recommendations for particular users of a set of users; and
utilizing an output modification algorithm to modify the recommendation output to produce modified recommendation output, at least to improve, relative to the recommendation output, the diversity of recommendations within at least one social group that includes at least some of the set of users,
wherein the modified recommendation output is for use by the recommendation system in determining recommendations to users of the set of users.
